(19) United States
(12) Patent Application Publication
(10) Pub. No.: US 2016/0377771 A1
(43) Pub. Date: Dec. 29, 2016

(54) METHOD FOR FABRICATING COLOR FILTER SUBSTRATE, DISPLAY PANEL AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Yongshan ZHOU, Beijing (CN); Jingpeng LI, Beijing (CN); Zhenyu XIE, Beijing (CN)

(21) Appl. No.: 15/134,700

(22) Filed: Apr. 21, 2016

(30) Foreign Application Priority Data
Jun. 26, 2015 (CN) 201510364313.X

(51) Int. Cl. G02B 5/22; G02F 1/1337; G02F 1/1335

(52) U.S. Cl. CPC G02B 5/22; G02F 1/133516; G02F 1/133512; G02F 1/133788

(57) ABSTRACT

The present invention provides a method for fabricating a color filter substrate, including: carrying out a first ultraviolet light irradiation and a heating treatment on functional layers formed by patterning process on a substrate; forming an alignment layer on the functional layers; and carrying out a second ultraviolet light irradiation on the alignment layer. The present invention further provides a display panel including the color filter substrate fabricated by using the method and a display device including the display device.

### FIELD OF THE INVENTION

The present invention belongs to the field of display technology, and specifically relates to a method for fabricating a color filter substrate, a display panel and a display device.

### BACKGROUND OF THE INVENTION

In recent years, due to the advantages of light weight, small volume, no radiation, low power consumption, good display effect and the like, liquid crystal displays have gained a lot of popularity and become mainstream products.

A liquid crystal display panel includes an array substrate, a color filter substrate and a liquid crystal layer arranged between the array substrate and the color filter substrate. Light emitted by a backlight is incident from the array substrate, is selectively transmitted after the liquid crystal layer is controlled to deflect through the array substrate, and then passes through the color filter substrate to become light of corresponding color pixels.

In fabricating a liquid crystal display panel, the array substrate and the color filter substrate need to be assembled, in order to seal the liquid crystal layer therebetween. However, because the liquid crystal layer needs to be oriented in advance, an alignment layer needs to be formed on an incidence side (i.e., one side close to the liquid crystal layer) of the color filter substrate. Generally, the alignment layer may be aligned by using a rubbing alignment method. In addition, a photo alignment method has the advantages of simple orientation and gradually replaces the conventional rubbing alignment methods.

At present, common photo alignment methods includes photo degradation, photo-isomerization, photo-polymerization and the like, among them, a photo degradation type alignment layer is widely used. Usually, after functional layers of the color filter substrate layer have been fabricated, the photo degradation type alignment layer is coated on the functional layers, and since most of the functional layers are made from organic material, they include labile groups sensitive to ultraviolet light. When photo-aligning the photo degradation type alignment layer, these labile groups sensitive to ultraviolet light will be degraded as well. Since the photo degradation type alignment layer covers the functional layers, degradation products cannot be released out in time and will be gradually released in subsequent operations, so as to enter into the liquid crystal layer to form foreign bright spots, thereby seriously affecting the picture quality.

### SUMMARY OF THE INVENTION

An object of the present invention is to solve the problem in the prior art that, when photo-aligning an alignment layer with ultraviolet light, organic material functional layers fabricated prior to the alignment layer are degraded, and foreign bright spots are generated in a liquid crystal layer.

According to one aspect of the present invention, there is provided a method for fabricating a color filter substrate, including steps of: carrying out a first ultraviolet light irradiation and a heating treatment on functional layers formed by patterning process on a substrate; forming an alignment layer on the functional layers; and carrying out a second ultraviolet light irradiation on the alignment layer.

According to embodiments of the present invention, the functional layers may include: a color filter layer and a black matrix layer arranged in the same layer as the color filter layer; and a planarization layer and a supporting layer which are sequentially arranged on the color filter layer.

According to embodiments of the present invention, ultraviolet light in the first ultraviolet light irradiation may have the same wavelength as ultraviolet light in the second ultraviolet light irradiation.

According to embodiments of the present invention, the wavelengths of the ultraviolet light in the first ultraviolet light irradiation and the ultraviolet light in the second ultraviolet light irradiation may be in the range of 150 nm to 350 nm.

According to embodiments of the present invention, illuminance of the first ultraviolet light irradiation may be larger than or equal to that of the second ultraviolet light irradiation.

According to embodiments of the present invention, the illuminance the second ultraviolet light irradiation may be in the range of 200 Lux to 1000 Lux.

According to embodiments of the present invention, temperature of the heating treatment may be in the range of 200° C. to 250° C.

According to embodiments of the present invention, heating time of the heating treatment may be in the range of 10 minutes to 60 minutes.

According to embodiment of the present invention, the method for fabricating a color filter substrate may further include a step of: drying the aligned alignment layer.

According to embodiments of the present invention, drying temperature may be smaller than the temperature of the heating treatment.

According to embodiments of the present invention, a first ultraviolet light source may be adopted in the first ultraviolet light irradiation, and a second ultraviolet light source may be adopted in the second ultraviolet light irradiation.

According to another aspect of the present invention, there is provided a display panel, including a color filter substrate fabricated by using the method for fabricating a color filter substrate according to the present invention.

According to another aspect of the present invention, there is provided a display device, including the display panel according to the present invention.

In the method for fabricating a color filter substrate according to the present invention, before forming the alignment layer, the ultraviolet light irradiation and the heating treatment are carried out on the functional layers of the color filter substrate, so that decomposition products generated from the organic material in the functional layers due to the ultraviolet irradiation are volatilized to be removed, and thus the technical problem that foreign bright spots are formed in the liquid crystal layer to affect the display quality of the display panel is solved.

### BRIEF DESCRIPTION OF THE DRAWINGS

FIGS. 1 to 3 are schematic diagrams illustrating a method for fabricating a color filter substrate according to an embodiment of the present invention.

### DESCRIPTION OF THE PREFERRED EMBODIMENT

In order that those skilled in the art better understand the technical solutions of the present invention, the present invention will be further described in detail below in conjunction with the accompany drawings and specific implementations.

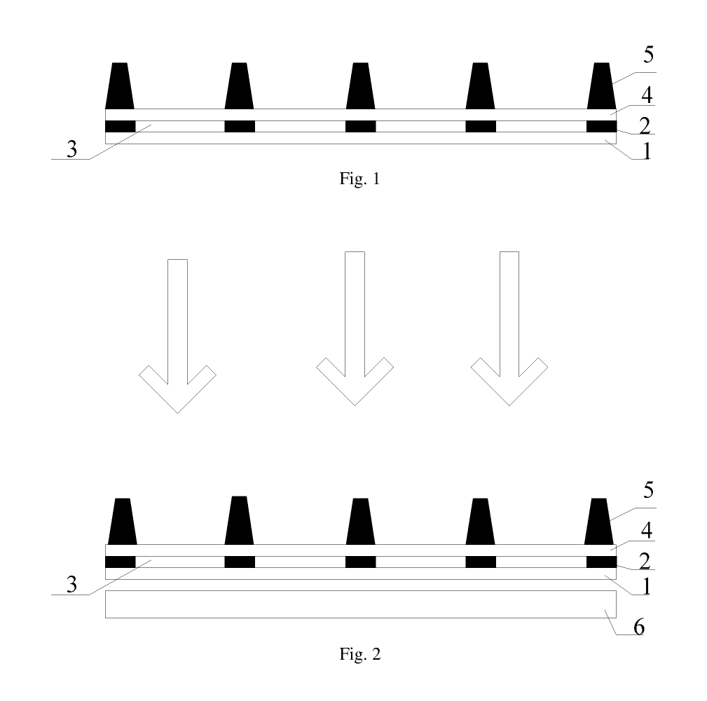

FIG. 1 shows a substrate 1 formed with functional layers.

As shown in FIG. 1, according to embodiments of the present invention, the functional layers may include a color filter layer 3 and a black matrix layer 2 arranged in the same layer as the color filter layer 3. In addition, the functional layers may further include a planarization layer 4 and a supporting layer 5 which are sequentially arranged on the color filter layer 3.

FIG. 2 shows a schematic diagram of carrying out an ultraviolet light irradiation on the substrate 1 formed with the functional layers.

As shown in FIG. 2, a method for fabricating a color filter substrate according to embodiments of the present invention includes steps of: carrying out a first ultraviolet light irradiation and a heating treatment on the functional layers formed by patterning process on the substrate 1. Thus, before forming an alignment layer covering the functional layers, decomposition products generated from organic material in the functional layers due to the ultraviolet irradiation can be removed.

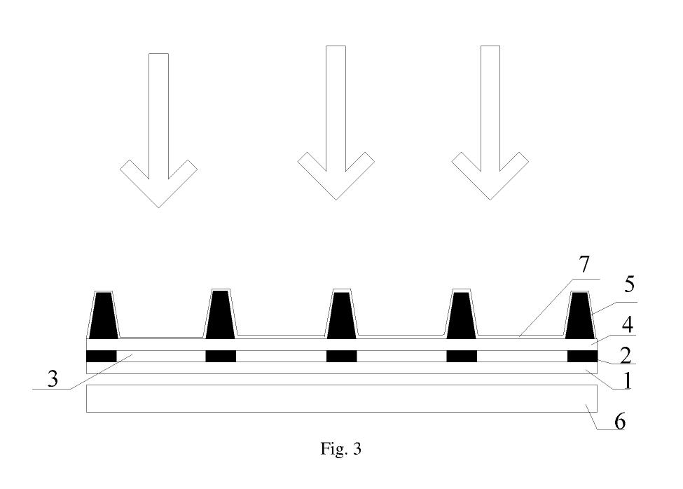

The method for fabricating the color filter substrate according to the embodiment of the present invention further includes: forming an alignment layer 7 on the functional layers; and carrying out a second ultraviolet light irradiation on the alignment layer 7, as shown in FIG. 3.

According to embodiments of the present invention, before forming the alignment layer 7, the first ultraviolet light irradiation and the heating treatment are carried out on the functional layers of the color filter substrate, so that the decomposition products generated from the organic material in the functional layers due to the ultraviolet light irradiation can be volatilized to be removed, and thus the decomposition products that are gradually released into a liquid crystal layer to form foreign bright spots will not be produced when forming the alignment layer 7 and performing the second ultraviolet light irradiation.

According to embodiments of the present invention, a heating plate 6 may be arranged below the substrate 1, as shown in FIG. 2. A first ultraviolet light source is used for irradiating, so as to decompose labile groups sensitive to ultraviolet light in the functional layers. Meanwhile, the heating treatment is carried out on the color filter substrate by the heating plate 6 to volatilize the decomposition products, so as to remove the same.

According to embodiments of the present invention, the temperature of the heating treatment may be in the range of 200° C. to 250° C., and the heating time of the heating treatment may be in the range of 10 minutes to 60 minutes. Within the ranges of the heating temperature and the heating time, the functional layers formed by the organic material will not deform, and the decomposition products resulted from the ultraviolet light irradiation are volatilized easily. In addition, the heating time may be selected according to specific conditions to completely volatilize the decomposition products resulted from the ultraviolet light irradiation.

According to embodiments of the present invention, the illuminance of the first ultraviolet light irradiation may be larger than 1000 Lux. With this illuminance, the labile groups sensitive to ultraviolet light in the functional layers can be fully decomposed. In addition, the ultraviolet light may have a wavelength suitable for photo-aligning a photo degradation type alignment layer, and for example, the wavelength may be in the range of 150 nm to 350 nm.

It should be understood that the light source of the first ultraviolet light may be not a linear polarized light source, but a light source with a relatively low cost. The light source of the second ultraviolet light may be a linear polarized light source to align the alignment layer 7. Linear polarized light may be produced by using an ultraviolet light source in conjunction with a polarizer, so as to reduce the cost.

According to embodiments of the present invention, the photo degradation type alignment layer 7 may be formed on the supporting layer 5 with polyimide, as shown in FIG. 3.

According to embodiments of the present invention, the ultraviolet light in the first ultraviolet light irradiation may has the same wavelength as the ultraviolet light in the second ultraviolet light irradiation. By adopting ultraviolet light having the same wavelength to align the alignment layer 7, it can be ensured that the functional layers formed by the organic material will not be degraded again.

According to embodiments of the present invention, the illuminance of the first ultraviolet light irradiation may be larger than or equal to that of the second ultraviolet light irradiation, in order to ensure that the functional layers formed by the organic material will not be degraded again in the process of aligning the alignment layer 7 by the second ultraviolet light irradiation. For example, the illuminance of the second ultraviolet light irradiation may be in the range of 200 Lux to 1000 Lux.

It should be understood that the illuminance of the second ultraviolet light irradiation and the illuminance and the wavelength of the first ultraviolet light irradiation may be adjusted according to specific applications, as long as it can be guaranteed that the alignment layer 7 can be normally aligned by the second ultraviolet light irradiation and the functional layers formed by the organic material will not be degraded again.

According to embodiments of the present invention, the method for fabricating a color filter substrate may further include a step of: drying the aligned alignment layer 7. The drying temperature may be smaller than the temperature of the heating treatment. For example, the drying temperature may be in the range of 200° C. to 250° C. At this drying temperature, it can be ensured that the organic material will not be volatilized again.

According to another aspect of the present invention, there is provided a display panel, including a color filter substrate fabricated by using the method for fabricating a color filter substrate according to the present invention.

In addition, according to another aspect of the present invention, there is provided a display device, including the display panel according to the present invention. The display device may be (but not limited to) any product or component with a display function, such as a mobile phone, a tablet computer, a TV set, a display, a notebook computer, a digital photo frame, a navigator, etc.

It can be understood that the above embodiments are merely exemplary embodiments used for illustrating the principle of the present invention, but the present invention is not limited thereto. Those of ordinary skill in the art can make various modifications and improvements without departing from the spirit and essence of the present invention, and these modifications and improvements are also encompassed within the protection scope of the present invention.

1. A method for fabricating a color filter substrate, comprising steps of:
carrying out a first ultraviolet light irradiation and a heating treatment on functional layers formed by patterning process on a substrate;
forming an alignment layer on the functional layers; and
carrying out a second ultraviolet light irradiation on the alignment layer.

2. The method of claim 1, wherein the functional layers comprises:
a color filter layer and a black matrix layer arranged in the same layer as the color filter layer; and
a planarization layer and a supporting layer which are sequentially arranged on the color filter layer.

3. The method of claim 1, wherein ultraviolet light in the first ultraviolet light irradiation has the same wavelength as ultraviolet light in the second ultraviolet light irradiation.

4. The method of claim 3, wherein the wavelengths of both the ultraviolet light in the first ultraviolet light irradiation and the ultraviolet light in the second ultraviolet light irradiation are in the range of 150 nm to 350 nm.

5. The method of claim 1, wherein illuminance of the first ultraviolet light irradiation is larger than or equal to that of the second ultraviolet light irradiation.

6. The method of claim 1, wherein the illuminance of the second ultraviolet light irradiation is in the range of 200 Lux to 1000 Lux.

7. The method of claim 1, wherein temperature of the heating treatment is in the range of 200° C. to 250° C.

8. The method of claim 1, wherein heating time of the heating treatment is in the range of 10 minutes to 60 minutes.

9. The method of claim 1, further comprising a step of:
drying the aligned alignment layer.

10. The method of claim 9, wherein drying temperature is smaller than temperature of the heating treatment.

11. The method of claim 1, wherein a first ultraviolet light source is adopted in the first ultraviolet light irradiation, and a second ultraviolet light source is adopted in the second ultraviolet light irradiation.

12. A display panel, comprising a color filter substrate fabricated by using the method of claim 1.

13. A display device, comprising the display panel of claim 12.
